(19) United States
(12) Patent Application Publication
(10) Pub. No.: US 2005/0286242 A1
(43) Pub. Date: Dec. 29, 2005

(54) Method and apparatus for storing and supporting a worklight

(75) Inventors: Kenneth Earl Ramsey, Fayetteville, GA (US); George Michael Drake, Newnan, GA (US)

Correspondence Address: HAYNES AND BOONE, LLP, 901 MAIN STREET, SUITE 3100, DALLAS, TX, 75202, US

(73) Assignee: Cooper Industries, Ltd., Houston, TX (US)

(21) Appl. No.: 11/170,505

(22) Filed: Jun. 29, 2005

Related U.S. Application Data
(63) Continuation-in-part of application No. 29/193,725, filed on Nov. 12, 2003.

(51) Int. Cl. F21V 33/00

(52) U.S. Cl. 362/86; 362/253

(57) ABSTRACT

A worklight storing and supporting apparatus includes a chassis defining a worklight storage enclosure, a worklight support coupled to the chassis, and an audio device mounted in the chassis.

### CROSS REFERENCE TO RELATED APPLICATIONS

This application is a continuation-in-part of U.S. patent application Ser. No. 29/193725, filed on Nov. 12, 2003, the disclosure of which is incorporated herein by reference.

### BACKGROUND

This invention relates generally to worklights, and in particular to a method and apparatus for storing and supporting a worklight.

At a conventional worksite, a number of items are typically brought to the site to facilitate work such as, for example, worklights for lighting the worksite, protective containers to protect the worklights, stands for mounting the worklights and directing their light, and audio devices for entertainment. Transporting all these items to and from the worksite can be cumbersome, requiring multiple trips which waste time and resources.

Therefore, what is needed is a method and apparatus for storing and supporting a worklight which addresses the problems of the prior methods discussed above.

### SUMMARY

According to one aspect of the present disclosure, a worklight storing and supporting apparatus is provided which includes a chassis defining a worklight storage enclosure, a worklight support coupled to the chassis, and an audio device mounted in the chassis.

According to another aspect of the present disclosure, a worklight storing and supporting apparatus is provided which includes a chassis defining a worklight storage enclosure and capable of forming a first point of contact with a support surface, an audio device mounted in the chassis, an extendable worklight support coupled to the chassis, at least one worklight dimensioned to be stored within the worklight chassis enclosure, the worklight including a clamp operable to releasably secure the worklight to the worklight support, and a door moveably coupled to the chassis and operable between a closed and open position, whereby in the open position the door is operable to form a second point of contact with the support surface, the second point of contact being smaller in size than the first point of contact.

According to another aspect of the present disclosure, a method for storing and supporting a worklight is provided which includes providing a chassis defining a worklight storage enclosure and comprising a worklight support and an audio device coupled to the chassis, and storing at least one worklight in the worklight storage enclosure.

According to another aspect of the present disclosure, a worklight storing and supporting apparatus is provided which includes a chassis defining a worklight storage enclosure and a plurality of speaker apertures, at least one door moveably coupled to the chassis and including an extendable stabilizing leg, whereby the door may be moved to an open position such that the stabilizing leg provides stabilizing support for the chassis, an extendable worklight support coupled to the chassis, a handle coupled to the worklight support, a plurality of wheels coupled to the chassis, at least one worklight, the worklight operable to be stored in the worklight storage enclosure or coupled to the worklight support, an audio device mounted in the chassis, and at least one speaker coupled to the audio device and the chassis and positioned adjacent the speaker apertures.

According to another aspect of the present disclosure, a worklight storing and supporting apparatus is provided which includes a chassis defining a worklight storage enclosure, a plurality of speaker apertures, and capable of forming a first point of contact with a support surface, an audio device mounted in the chassis, at least one speaker coupled to the audio device and the chassis, an extendable worklight support coupled to the chassis, at least one worklight dimensioned to be stored within the worklight chassis enclosure, the worklight including a clamp operable to releasably secure the worklight to the worklight support, and a door moveably coupled to the chassis and operable between a closed and open position, whereby in the open position the door is operable to form a second point of contact with the support surface, the second point of contact being smaller in size than the first point of contact.

According to another aspect of the present disclosure a method for storing and supporting a worklight is provided which includes providing a chassis defining a worklight storage enclosure and comprising a worklight support and an audio device coupled to the chassis, storing at least one worklight in the worklight storage enclosure, removing the worklight from the worklight storage area, coupling the worklight to the worklight support, and operating the audio device.

### BRIEF DESCRIPTION OF THE DRAWINGS

FIG. 1a is a perspective view illustrating an exemplary embodiment of a chassis.

FIG. 1b is a perspective view illustrating an exemplary embodiment of the chassis of FIG. 1a.

FIG. 1c is a cross sectional view illustrating an exemplary embodiment of the chassis of FIG. 1b.

FIG. 2 is a perspective view illustrating an exemplary embodiment of a worklight used with the chassis of FIG. 1a.

FIG. 3a is a flow chart illustrating an exemplary embodiment of a method for storing and supporting a worklight.

FIG. 3b is a perspective view illustrating an exemplary embodiment of the worklight of FIG. 2 stored in the chassis of FIG. 1a.

FIG. 3c is a perspective view illustrating an exemplary embodiment of the worklight of FIG. 2 supported by the chassis of FIG. 1a.

FIG. 3d is a perspective view illustrating an exemplary embodiment of the chassis of FIG. 1b with the audio device removed.

FIG. 4a is a perspective view illustrating an exemplary embodiment of a chassis.

FIG. 4b is a cross sectional view illustrating an exemplary embodiment of the chassis of FIG. 4a.

### DETAILED DESCRIPTION OF THE ILLUSTRATIVE EMBODIMENTS

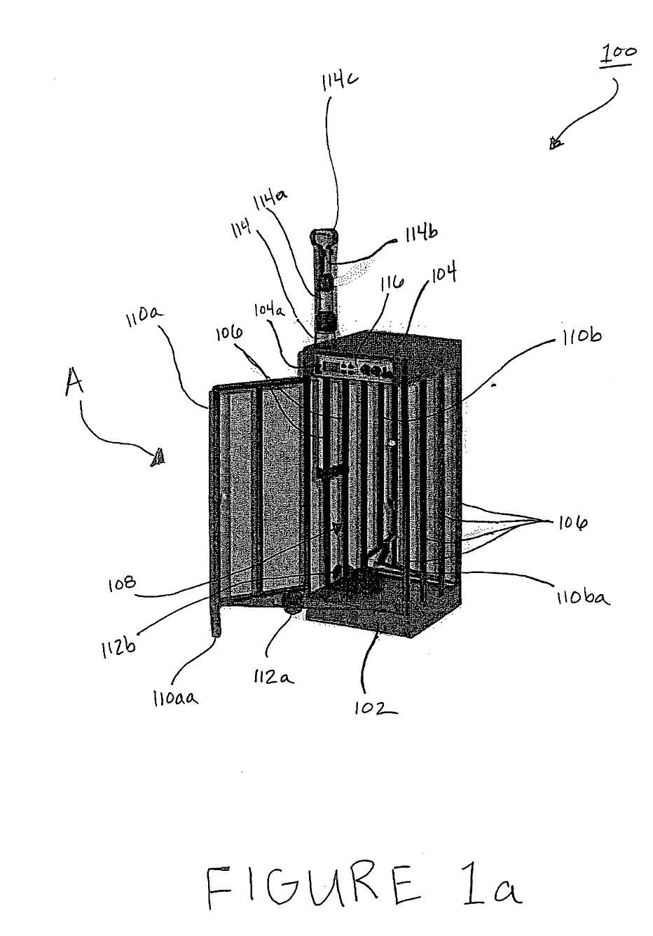

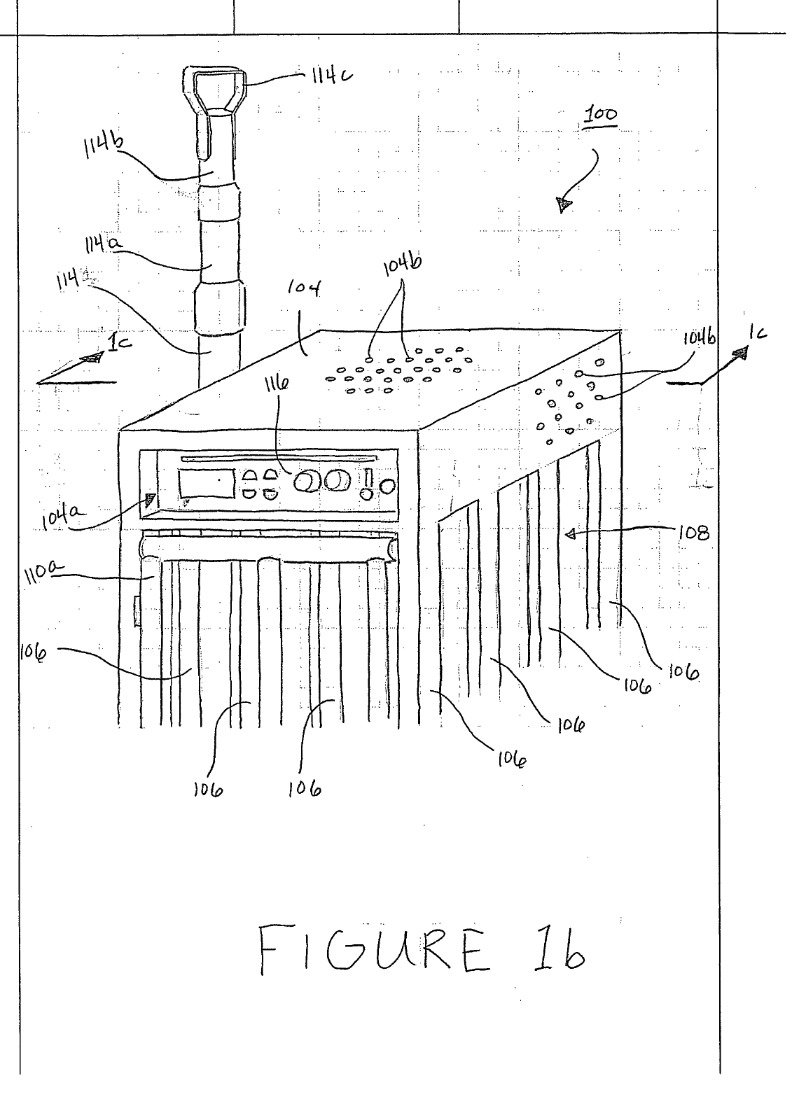

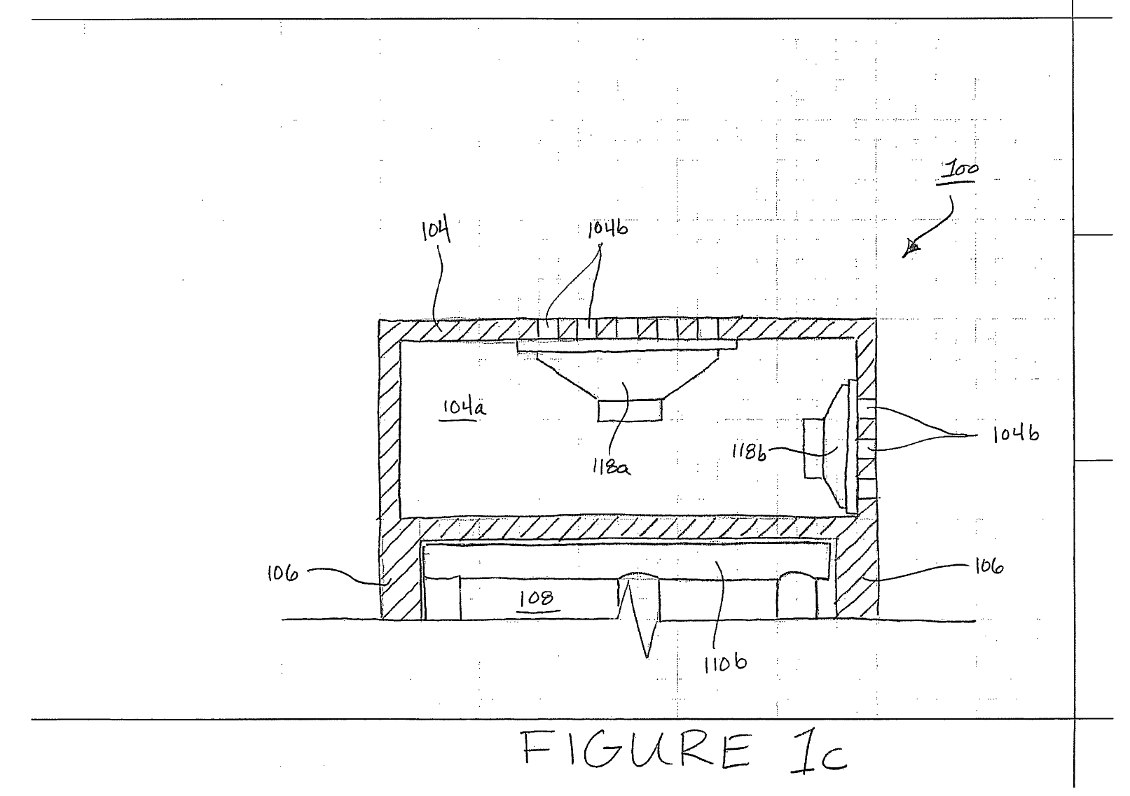

Referring now to FIGS. 1a, 1b, and 1c, a chassis 100 is illustrated. Chassis 100 includes a base member 102 and a top member 104 which are spaced apart and coupled together by a plurality of bars 106 extending between the base member 102 and the top member 104 on opposite sides of the base member 102 and the top member 104.

The base member 102, top member 104, and the plurality of bars 106 define a worklight storage enclosure 108 located between them and along the length of the chassis 100. A device mounting channel 104a is defined by the top member 104 and located along the length of the top member 104. A plurality of speaker apertures 104b are defined by the top member 104 and extend through the top member 104 and to the device mounting channel 104a.

A plurality of doors 110a and 110b are pivotally coupled to the chassis 100 between the base member 102 and the top member 104, each including a leg 110aa and 110ba extending from the bottom of the leg 110a and 110b, respectively. In an exemplary embodiment, the legs 110aa and 110ba are extendable from and retractable to the doors 110a and 110b, respectively.

A plurality of wheels 112a and 112b are rotatably coupled to the base member 102 in a spaced apart orientation. A worklight support 114 is coupled to the bars 106 and, in an exemplary embodiment, includes a plurality of tubular members 114a and 114b which are telescopically coupled to each other and the worklight support 114 and are operable to extend from and retract to the chassis 100. A handle 114c is pivotally coupled to a distal end of the tubular member 114b.

An audio device 116 is positioned in the device mounting channel 104a and mounted to the chassis 100, and a plurality of speakers 118a and 118b are coupled to the chassis 100 and the audio device 116 and positioned adjacent the speaker apertures 104b. In an exemplary embodiment, the audio device 116 may be a variety of audio devices known in the art such as, for example, terrestrial or satellite radios, audio cassette players such as tape players, audio disc players such as compact disc players, digital audio players such as MP3 players, and combinations thereof. While a variety of exemplary audio devices have been suggested, it should be understood that the audio device 116 is meant to encompass any device which allows an audio signal to be transmitted from the audio device 116 to, for example, the speakers 118a and 118b. Furthermore, in an exemplary embodiment, the audio device 116 may include a coupling for connecting a conventional speaker which is external to the chassis 100 to the audio device 116.

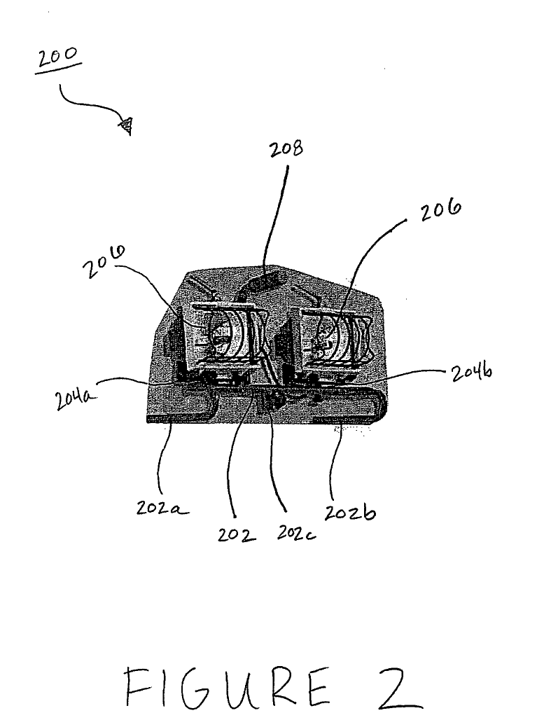

Referring now to FIG. 2, a worklight 200 is illustrated. Worklight 200 includes a stand 202 having a plurality of spaced apart legs 202a and 202b extending from opposing ends of the stand 202. A support coupling member 202c is mounted to the stand 202 and centrally located on the stand 202 between the legs 202a and 202b. A plurality of fixture couplers 204a and 204b are mounted to the stand 202 in a spaced apart orientation between the legs 202a and 202b. A light fixture 206 is mounted to each of the fixture couplers 204a and 204b, and the fixture couplers 204a and 204b allow the light fixtures 206 to be moved into a variety of orientations atop the stand 202 and relative to the stand 202. A handle 208 extends from the stand 202 from a central location between the legs 202a and 202b and is located between the lights 206 on light fixtures 204a and 204b.

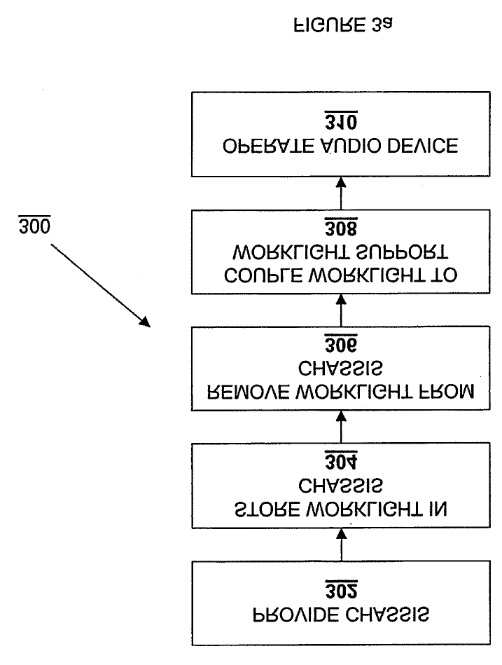

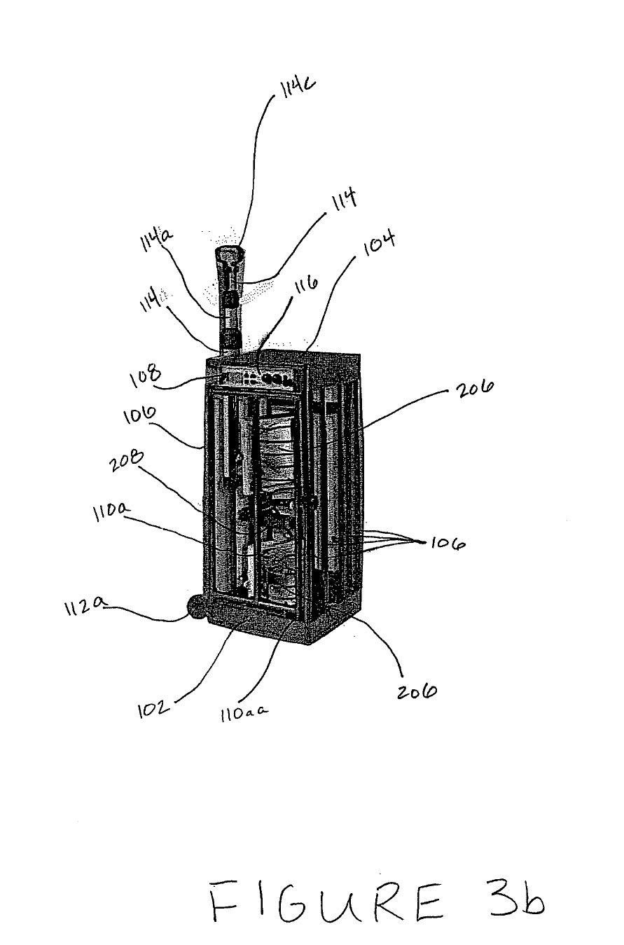

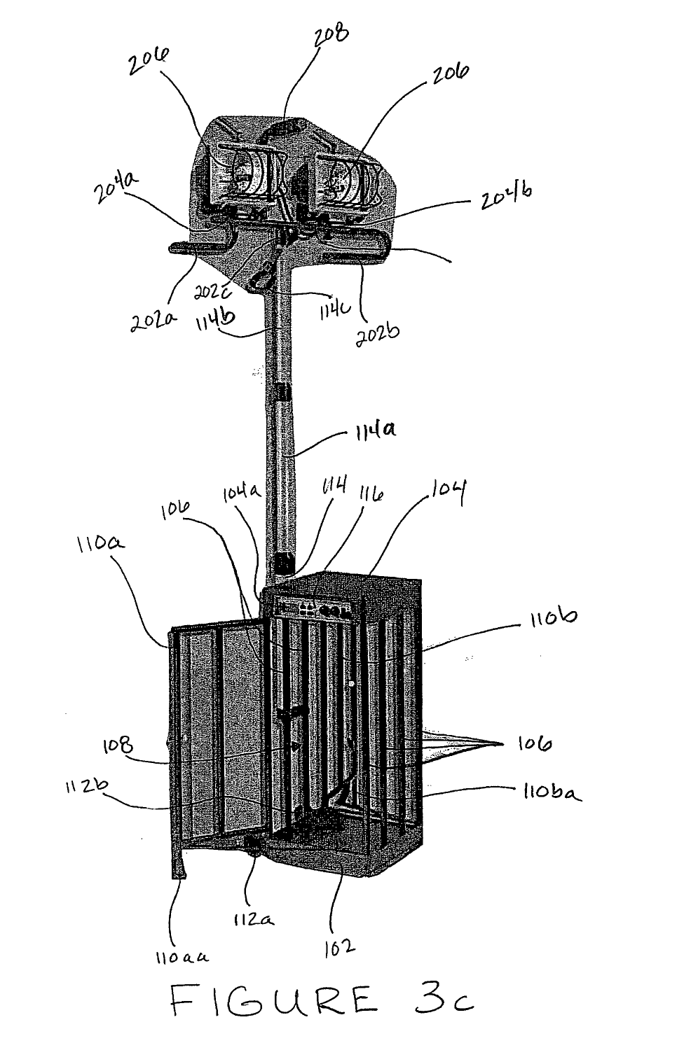

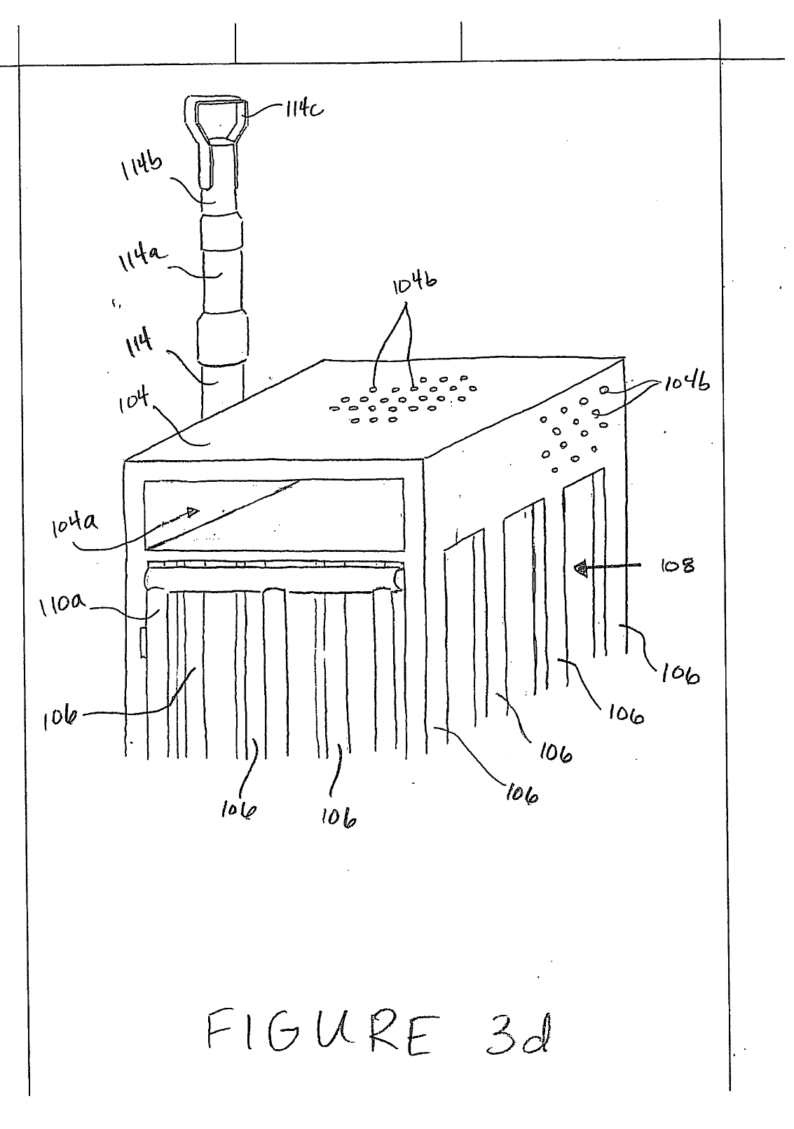

Referring now to FIGS. 1a, 2, 3a, and 3b, a method 300 for storing and supporting a worklight is illustrated. The method 300 begin at step 302 where the chassis 100 is provided including the worklight storage enclosure 108, the worklight support 114, and the audio device 116. The method 300 then proceeds to step 304 where the worklight 200 is stored in the chassis 100. The door 110a is moved to an open position A to provide access to the worklight storage enclosure 108, as illustrated in FIG. 1a. The worklight 200 is then positioned adjacent the chassis 100 and oriented such that the leg 202a is adjacent the base member 102 on chassis 100 and the leg 202b is adjacent the top member 104. The worklight 200 may then be positioned in the worklight storage enclosure 108 and the door 110a may be moved to a closed position B, storing the worklight 200 in the chassis 100, as illustrated in FIG. 3b.

Referring now to FIGS. 1a, 2, 3a, 3c, and 3d, the method 300 proceeds to step 306 where the worklight 200 is removed from the chassis 100. The door 110a is moved to the open position A, allowing the worklight 200 to be removed from the worklight storage enclosure 108, as illustrated in FIG. 1a. The method 300 then proceeds to step 308 where the worklight 200 is coupled to the worklight support 114. The worklight support 114 is extended from the chassis 100 by moving the tubular member 114a telescopically relative to the worklight support 114, moving the tubular member 114b telescopically relative to the tubular member 114a, and locking both tubular members 114a and 114b in position using conventional methods known in the art. The handle 114c is then rotated about the tubular member 114b to allow the support coupling member 202c on the worklight 200 to be coupled to the distal end of the tubular member 114b, as illustrated in FIG. 3c. The doors 110a and 110b may both be moved to the open position A to provide additional support for the worklight 200 by having legs 110aa and 110ba engage the surface that the chassis 100 is positioned on. The method 300 then proceeds to step 310 where the audio device 116 is operated.

The audio device 116 may be operated to transmit, for example, pre-recorded or broadcast content such as, for example, terrestrial radio broadcasts, satellite radio broadcasts, and/or pre-recorded material on an audio cassette, audio disc, digital audio file, to the speakers 118a and 118b while the worklight 200 is being used. In an exemplary embodiment, the audio device 116 may be operated at any time before, during, or after the method 300. Thus, an integrated apparatus and method are provided which allow a worklight 200 to be stored and supported and includes an audio device 116 in an easy-to-transport chassis 100. In an exemplary embodiment, the audio device 116 may be connected to the chassis 100 and the speakers 118a and 118b using a quick connect apparatus known in the art which allows the audio device to be removed from the device mounting channel 104a, as illustrated in FIG. 3d.

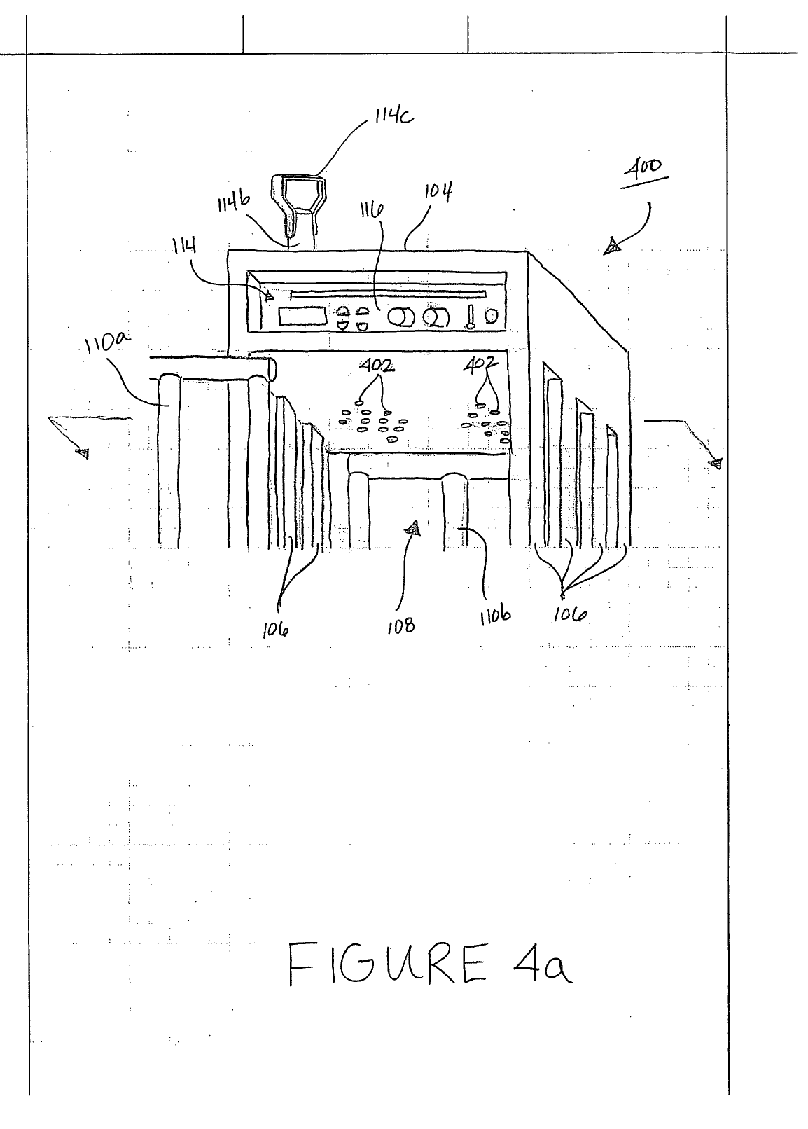

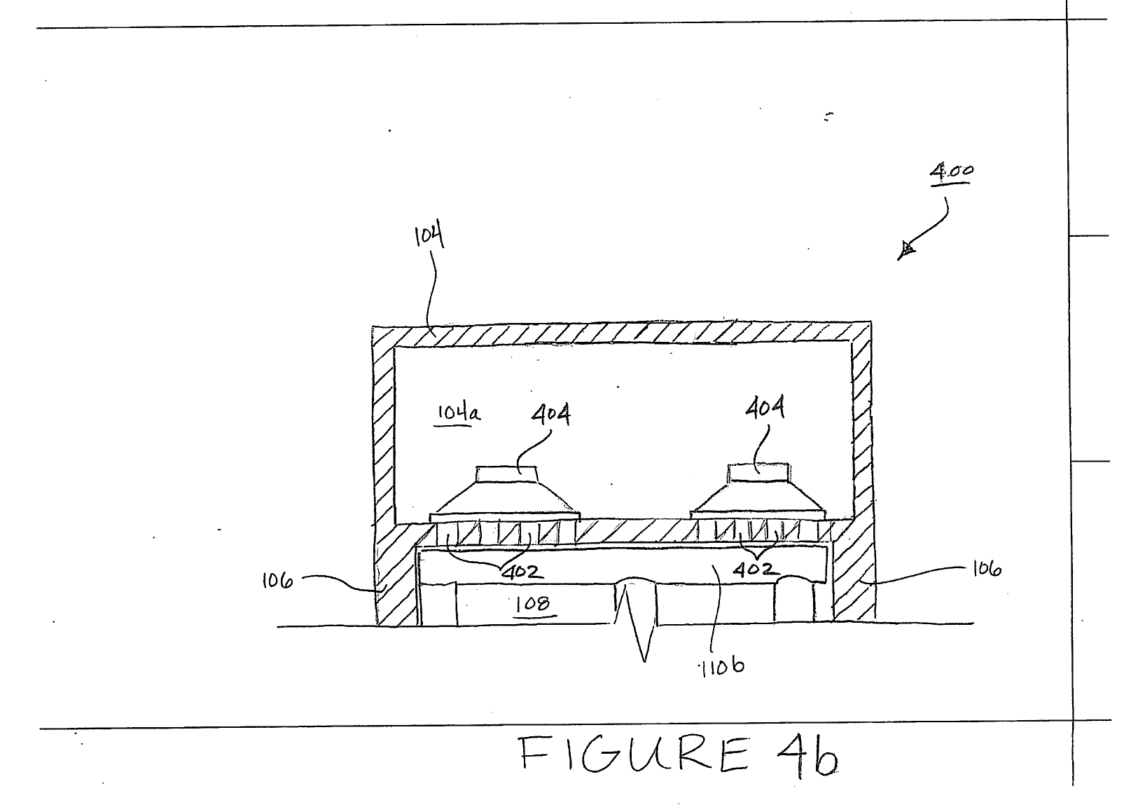

Referring now to FIGS. 4a and 4b, in an alternative embodiment, a chassis 400 is provided which is substantially similar in design and operation to the chassis 100 described above with reference to FIGS. 1a, 1b, 1c, 2, 3a, 3b, 3c, and 3d, with the provision of a plurality of speaker apertures 402 which are defined by the top member 104 and positioned on a bottom section of the top member 104 replacing the speaker apertures 104b on chassis 100. A plurality of speakers 404 are coupled to the chassis 400 and the audio device 116 and positioned adjacent the speaker apertures 402, replacing the speakers 118a and 118b in chassis 100. The alternative embodiment of chassis 400, illustrated in FIGS. 4a and 4b, provides a chassis 400 with a top member 104 with a solid top section that protects the audio device 116 from elements which may be able to enter the device mounting channel 114 through apertures defined in the top section of the top member 104.

In an exemplary embodiment, the chassis 100 and 400, without the device mounting channel 104a, the speaker apertures 104b and 402, the audio device 116, and the speakers 118a, 118b, and 404, are provided substantially as disclosed in U.S. Pat. No. 6,682,209, the disclosure of which is incorporated herein by reference.

A worklight storing and supporting apparatus has been described that includes a chassis defining a worklight storage enclosure, a worklight support coupled to the chassis, and an audio device mounted in the chassis. In an exemplary embodiment, the audio device comprises an audio device chosen from the group consisting of a radio, an audio cassette player, a audio disk player, a digital audio player, and combinations thereof. In an exemplary embodiment, the audio device comprises at least one speaker coupled to the chassis. In an exemplary embodiment, the chassis defines a plurality of apertures for allowing sound from a speaker positioned inside the chassis to be heard outside the chassis. In an exemplary embodiment, the audio device is removeable from the chassis. In an exemplary embodiment, the worklight support is extendable from and retractable to the chassis. In an exemplary embodiment, the apparatus further includes at least one worklight, the worklight operable to be stored in the worklight storage enclosure or coupled to the worklight support. In an exemplary embodiment, the apparatus further includes at least one door moveably coupled to the chassis and including a stabilizing leg, whereby the door may be moved to an open position such that the stabilizing leg provides stabilizing support for the chassis. In an exemplary embodiment, the stabilizing leg is extendable from and retractable to the door. In an exemplary embodiment, the apparatus further includes a handle coupled to the worklight support. In an exemplary embodiment, the apparatus further includes a plurality of wheels coupled to the chassis.

A worklight storing and supporting apparatus has been described that includes a chassis defining a worklight storage enclosure and capable of forming a first point of contact with a support surface, an audio device mounted in the chassis, an extendable worklight support coupled to the chassis, at least one worklight dimensioned to be stored within the worklight chassis enclosure, the worklight including a clamp operable to releasably secure the worklight to the worklight support, and a door moveably coupled to the chassis and operable between a closed and open position, whereby in the open position the door is operable to form a second point of contact with the support surface, the second point of contact being smaller in size than the first point of contact. In an exemplary embodiment, the audio device comprises an audio device chosen from the group consisting of a radio, an audio cassette player, a compact disk player, a digital audio player, and combinations thereof. In an exemplary embodiment, the audio device comprises at least one speaker coupled to the chassis. In an exemplary embodiment, the chassis includes a plurality of apertures for allowing sound from a speaker positioned inside the chassis to be heard outside the chassis. In an exemplary embodiment, the audio device is removeable from the chassis. In an exemplary embodiment, the door comprises an extandable leg which is adjustable in length.

A method for storing and supporting a worklight has been described that includes providing a chassis defining a worklight storage enclosure and comprising a worklight support and an audio device coupled to the chassis, and storing at least one worklight in the worklight storage enclosure. In an exemplary embodiment, the method further includes removing the worklight from the worklight storage area, and coupling the worklight to the worklight support. In an exemplary embodiment, the method further includes operating the audio device.

A worklight storing and supporting apparatus has been described that includes a chassis defining a worklight storage enclosure and a plurality of speaker apertures, at least one door moveably coupled to the chassis and including an extendable stabilizing leg, whereby the door may be moved to an open position such that the stabilizing leg provides stabilizing support for the chassis, an extendable worklight support coupled to the chassis, a handle coupled to the worklight support, a plurality of wheels coupled to the chassis, at least one worklight, the worklight operable to be stored in the worklight storage enclosure or coupled to the worklight support, an audio device mounted in the chassis, and at least one speaker coupled to the audio device and the chassis and positioned adjacent the speaker apertures.

A worklight storing and supporting apparatus has been described that includes a chassis defining a worklight storage enclosure, a plurality of speaker apertures, and capable of forming a first point of contact with a support surface, an audio device mounted in the chassis, at least one speaker coupled to the audio device and the chassis, an extendable worklight support coupled to the chassis, at least one worklight dimensioned to be stored within the worklight chassis enclosure, the worklight including a clamp operable to releasably secure the worklight to the worklight support, and a door moveably coupled to the chassis and operable between a closed and open position, whereby in the open position the door is operable to form a second point of contact with the support surface, the second point of contact being smaller in size than the first point of contact.

A method for storing and supporting a worklight has been described that includes providing a chassis defining a worklight storage enclosure and comprising a worklight support and an audio device coupled to the chassis, storing at least one worklight in the worklight storage enclosure, removing the worklight from the worklight storage area, coupling the worklight to the worklight support, and operating the audio device.

It is understood that variations may be made in the foregoing without departing from the scope of the invention. Furthermore, the elements and teachings of the various illustrative embodiments may be combined in whole or in part in some or all of the illustrative embodiments. In addition, one or more of the elements and teachings of the various illustrative embodiments may be omitted, at least in part, and/or combined, at least in part, with one or more of the other elements and teachings of the various illustrative embodiments.

Although illustrative embodiments of the invention have been shown and described, a wide range of modification, changes and substitution is contemplated in the foregoing disclosure. In some instances, some features of the present invention may be employed without a corresponding use of the other features. Accordingly, it is appropriate that the appended claims be construed broadly and in a manner consistent with the scope of the invention.

1. A worklight storing and supporting apparatus comprising:
a chassis defining a worklight storage enclosure;
a worklight support coupled to the chassis; and
an audio device mounted in the chassis.

2. The apparatus of claim 1 wherein the audio device comprises an audio device chosen from the group consisting of a radio, an audio cassette player, a audio disk player, a digital audio player, and combinations thereof.

3. The apparatus of claim 1 wherein the audio device comprises at least one speaker coupled to the chassis.

4. The apparatus of claim 1 wherein the chassis defines a plurality of apertures for allowing sound from a speaker positioned inside the chassis to be heard outside the chassis.

5. The apparatus of claim 1 wherein the audio device is removeable from the chassis.

6. The apparatus of claim 1 wherein the worklight support is extendable from and retractable to the chassis.

7. The apparatus of claim 1 further comprising:
at least one worklight, the worklight operable to be stored in the worklight storage enclosure or coupled to the worklight support.

8. The apparatus of claim 1 further comprising:
at least one door moveably coupled to the chassis and including a stabilizing leg, whereby the door may be moved to an open position such that the stabilizing leg provides stabilizing support for the chassis.

9. The apparatus of claim 8 wherein the stabilizing leg is extendable from and retractable to the door.

10. The apparatus of claim 1 further comprising:
a handle coupled to the worklight support.

11. The apparatus of claim 1 further comprising:
a plurality of wheels coupled to the chassis.

12. A worklight storing and supporting apparatus comprising:
a chassis defining a worklight storage enclosure and capable of forming a first point of contact with a support surface;
an audio device mounted in the chassis;
an extendable worklight support coupled to the chassis;
at least one worklight dimensioned to be stored within the worklight chassis enclosure, the worklight including a clamp operable to releasably secure the worklight to the worklight support; and
a door moveably coupled to the chassis and operable between a closed and open position, whereby in the open position the door is operable to form a second point of contact with the support surface, the second point of contact being smaller in size than the first point of contact.

13. The apparatus of claim 12 wherein the audio device comprises an audio device chosen from the group consisting of a radio, an audio cassette player, a compact disk player, a digital audio player, and combinations thereof.

14. The apparatus of claim 12 wherein the audio device comprises at least one speaker coupled to the chassis.

15. The apparatus of claim 12 wherein the chassis includes a plurality of apertures for allowing sound from a speaker positioned inside the chassis to be heard outside the chassis.

16. The apparatus of claim 12 wherein the audio device is removeable from the chassis.

17. The apparatus of claim 12 wherein the door comprises an extandable leg which is adjustable in length.

18. A method for storing and supporting a worklight comprising:
providing a chassis defining a worklight storage enclosure and comprising a worklight support and an audio device coupled to the chassis; and
storing at least one worklight in the worklight storage enclosure.

19. The method of claim 18 further comprising:
removing the worklight from the worklight storage area; and
coupling the worklight to the worklight support.

20. The method of claim 18 further comprising:
operating the audio device.

21. A worklight storing and supporting apparatus comprising:
a chassis defining a worklight storage enclosure and a plurality of speaker apertures;
at least one door moveably coupled to the chassis and including an extendable stabilizing leg, whereby the door may be moved to an open position such that the stabilizing leg provides stabilizing support for the chassis;
an extendable worklight support coupled to the chassis;
a handle coupled to the worklight support;
a plurality of wheels coupled to the chassis;
at least one worklight, the worklight operable to be stored in the worklight storage enclosure or coupled to the worklight support;
an audio device mounted in the chassis; and
at least one speaker coupled to the audio device and the chassis and positioned adjacent the speaker apertures.

22. A worklight storing and supporting apparatus comprising:
a chassis defining a worklight storage enclosure, a plurality of speaker apertures, and capable of forming a first point of contact with a support surface;
an audio device mounted in the chassis;
at least one speaker coupled to the audio device and the chassis;
an extendable worklight support coupled to the chassis;
at least one worklight dimensioned to be stored within the worklight chassis enclosure, the worklight including a clamp operable to releasably secure the worklight to the worklight support; and
a door moveably coupled to the chassis and operable between a closed and open position, whereby in the open position the door is operable to form a second point of contact with the support surface, the second point of contact being smaller in size than the first point of contact.

23. A method for storing and supporting a worklight comprising:
providing a chassis defining a worklight storage enclosure and comprising a worklight support and an audio device coupled to the chassis;
storing at least one worklight in the worklight storage enclosure;
removing the worklight from the worklight storage area;
coupling the worklight to the worklight support; and
operating the audio device.
